(19) United States
(12) Patent Application Publication
(10) Pub. No.: US 2026/0074648 A1
(43) Pub. Date: Mar. 12, 2026

(54) SOLAR PANEL MOUNTING SYSTEMS FOR ROTATABLE SOLAR PANELS

(71) Applicant: Vaja AB, Stockholm (SE)

(72) Inventors: Anders Olsson, Stockholm (SE); Henrik Eskilsson, Danderyd (SE); Mattias Kuldkepp, Sollentuna (SE)

(21) Appl. No.: 19/320,148

(22) Filed: Sep. 5, 2025

(30) Foreign Application Priority Data
Sep. 6, 2024 (SE) 2430447-9

(51) Int. Cl. H02S 20/32; G05D 3/10

(52) U.S. Cl. CPC H02S 20/32; G05D 3/105

(57) ABSTRACT

A solar panel mounting system includes a rotatable vertical support member, a lower solar panel support member for supporting at least one solar panel in a rest position, and an upper solar panel support member rotatably attached to the at least one solar panel. One or more connection members attach the at least one solar panel to the upper solar panel support member, allowing the at least one solar panel to rotate relative to the upper solar panel support member. Wind force upon a surface of the at least one solar panel causes the at least one solar panel to rotate around the upper solar panel support member out of the rest position. The system may include a motor connected to the rotatable vertical support member for driving rotation, a computing unit for controlling the motor, and a ground anchoring system for the rotatable vertical support member.

### FIELD OF THE INVENTION

The present relates to solar energy capturing systems, specifically to solar panel mounting systems that accommodate wind forces.

### BACKGROUND

Solar energy capturing systems convert light energy to electricity. The conversion of light to electricity is performed by a solar cell, also known as a photovoltaic cell. The solar cell can be a crystalline silicon cell, a thin-film cell, or similar. A number of solar cells are connected to each other, in combination with at least one protective layer, to form what is commonly referred to as a solar panel. The protective layer protects the solar cells from water, and in some cases also from wind, hail, and other environmental factors. A solar panel can be provided with a frame or it can be frameless. Generally, the solar panel can be connected to a junction box that is electrically wired to the solar cells of the solar panel. The junction box typically has a bypass diode and cables for electrically connecting to another junction box for another solar panel, to an inverter, a battery, or similar. In this manner, the solar panel can be short-circuited if it generates no or too little electricity.

Solar energy capturing systems aim to maximize the conversion of light to electricity. This involves optimizing the orientation and positioning of solar panels to capture the maximum amount of sunlight throughout the day. Solar panels are often mounted on structures that allow them to track the movement of the sun across the sky. This tracking can be achieved through various mechanisms, including dual-axis trackers, horizontal single-axis trackers, and vertical single-axis trackers. Additionally, solar panels must be mounted in a manner that can withstand environmental forces such as wind, rain, and hail. The goal is to ensure that the solar panels remain operational and efficient under varying weather conditions.

One of the primary challenges in solar energy capturing systems is the need to accommodate wind forces. Wind can exert significant pressure on solar panels, potentially causing damage or reducing their efficiency. Traditional solutions to this problem include using strong and heavy mounting materials, driving supports deep into the ground, and rigidly securing the solar panels to prevent movement. However, these solutions can be costly and may not always be effective in high-wind conditions. Another challenge is ensuring that the solar panels can rotate to follow the sun's movement while also being able to withstand wind forces without sustaining damage.

US2022151163 describes a method and apparatus for generating solar power in agricultural fields while minimally impacting crop growth and farming efforts. The system includes positioning an elongated solar panel above crops and automatically pivoting the solar panel to optimize sunlight exposure and protect against rain and heavy farm equipment. However, this system does not address the issue of wind forces acting on the solar panels.

U.S. application Ser. No. 16/413,352 (corresponding to U.S. Pat. No. 11,165,384B1) discloses a photovoltaic module or an array of modules pivotally mounted from an upper edge, designed to swing under the force of gravity in response to wind. However, this system relies on gravity and does not provide a mechanism for actively controlling the orientation of the solar panels based on wind conditions.

U.S. Pat. No. 9,494,343B2 discloses a partially non-rigid solar capture mounting system that reduces the risk of damage due to wind. The system includes a horizontal beam and backing plates that pivot in response to wind pressure. However, this system does not provide a method for actively rotating the solar panels to optimize their orientation based on wind conditions.

US20100077592 discloses a method for hanging solar panels from a horizontal support, with a counterweight to tilt the panels for increased sun exposure. However, this system does not address the issue of wind forces acting on the solar panels.

WO2023214396 discloses a system for mounting solar panels from vertical supports, where the panels rotate freely around a pivot formed by a hinge connection. However, this solution does not accommodate wiring electronics and does not provide a method for actively controlling the orientation of the solar panels based on wind conditions.

There is thus a need for a solar panel mounting system that can accommodate large wind forces while providing a simple, cost-effective method for mounting the solar panels. The system should allow for the active rotation of the solar panels to optimize their orientation based on wind conditions, thereby reducing the risk of damage and maintaining efficiency.

### SUMMARY

According to one aspect of the present invention, a solar panel mounting system for mounting one or more solar panels comprises a rotatable vertical support member, a lower solar panel support member for supporting the at least one solar panel in a rest position, an upper solar panel support member rotatably attached to the at least one solar panel, and one or more connection members attaching the at least one solar panel to the upper solar panel support member, allowing the at least one solar panel to rotate relative to the upper solar panel support member, wherein wind force upon a surface of the at least one solar panel causes the at least one solar panel to rotate around the upper solar panel support member out of the rest position.

According to another aspect, the solar panel mounting system further comprises a motor connected to the rotatable vertical support member for driving rotation of the rotatable vertical support member.

According to yet another aspect, the solar panel mounting system further comprises a computing unit for controlling the motor.

According to another aspect, the computing unit controls the motor to rotate the rotatable vertical support member such that a rear surface of the at least one solar panel faces the direction of incoming wind.

According to yet another aspect, the solar panel mounting system further comprises one or more dampening members attached to the lower solar panel support member for reducing the impact of contact between the at least one solar panel and the lower solar panel support member when the at least one solar panel is in the rest position after rotation.

According to another aspect, the solar panel mounting system further comprises a measurement device for measuring external forces.

According to yet another aspect, the measurement device measures properties of wind, including speed and direction.

According to another aspect, the solar panel mounting system further comprises a ground anchoring system for securely attaching the rotatable vertical support member to the ground.

### BRIEF SUMMARY OF THE DRAWINGS

FIG. 1 shows a solar panel mounting system with a rotatable vertical support member, upper and lower solar panel support members, and a motor for driving rotation.

FIG. 2 shows a solar panel mounting system with a motor-driven rotatable vertical support member and a solar panel rotated by wind force.

FIG. 3 shows the solar panel mounting system with a motor-driven rotatable vertical support member and solar panels.

FIG. 4 shows a solar panel mounting system with a rotatable vertical support member, upper and lower solar panel support members, and a motor for driving rotation.

FIG. 5 shows a solar panel mounting system with a rotatable vertical support member, lower and upper solar panel support members, and at least one solar panel.

FIG. 6 shows a solar panel mounting system with multiple support members and a rotatable vertical support member.

FIG. 7 shows a solar panel mounting system with a rotatable vertical support member, upper and lower solar panel support members, and a foundation.

### DETAILED DESCRIPTION

Throughout the present disclosure, the following terms and definition may be used.

As used herein, a solar cell, aka a photovoltaic cell, is capable of generating electricity when illuminated by light. Solar cells are commonly available on the market, such as crystalline solar cells, mono crystalline solar cells, poly crystalline solar cells, thin-film solar cells, or the like.

As used herein, the term “solar panel” refers to a panel comprising one or more photovoltaic cells, aka solar cells.

According to one aspect of the present invention, there is provided a solar panel mounting system containing one or more solar panels. The one or more solar panels sway around a horizontal axis, the horizontal axis attached to a vertical support member around the center of the horizontal axis. The vertical support member is rotatable such that the vertical support member may be rotated to follow the movement of the sun in the sky.

According to a further aspect of the present invention, there is provided a solar panel mounting system having an inner vertical member fixed to the ground, either directly or via a ground anchoring system. Located over the inner vertical member is a rotatable vertical support member, which rotates around the inner vertical member. Fixedly attached to the rotatable vertical support member is a horizontal axis, preferably the point of attachment of the horizontal axis to the rotatable vertical support member is at or around the center of the horizontal axis. Attached to the horizontal axis are one or more solar panels, these panels are attached such that they may hang from the horizontal axis and sway in the presence of wind. The rotatable vertical support member may be rotated by a motor, the motor may be driven by a computing device which can determine the desired orientation of the solar panels based on measured or predicted wind conditions, or other conditions or requirements. To reduce or limit friction between the inner vertical member and the rotatable vertical support member, bearings may be positioned adjacent the top of the inner vertical member and the bottom of the rotatable vertical support member. In an alternative embodiment, the inner vertical member may be rotatable, while the rotatable vertical support member is not rotatable but is rather fixed to the ground as is herein described.

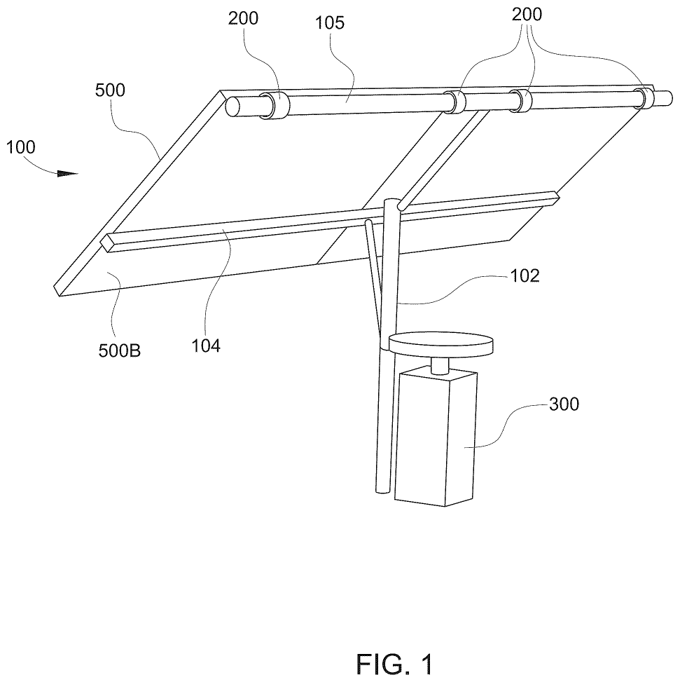

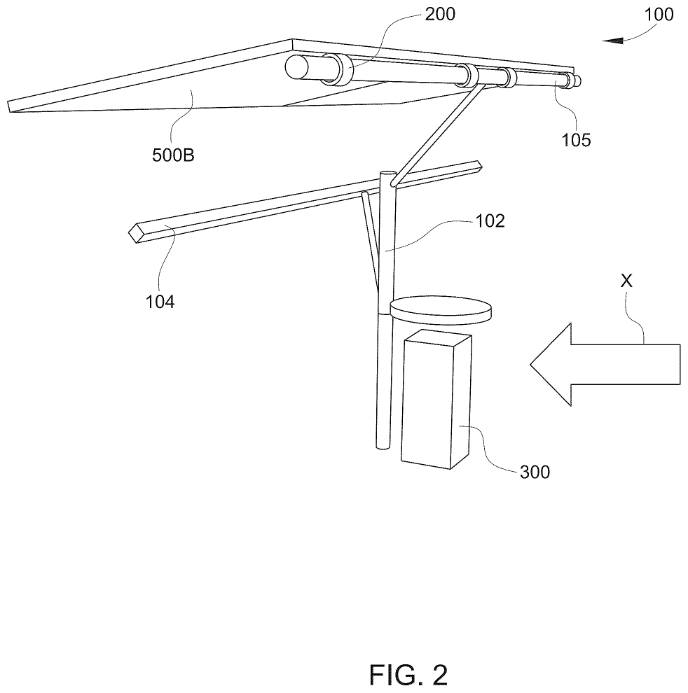

According to one aspect of the present invention, as shown in FIGS. 1 and 2, there is provided a solar panel mounting system 100 comprising a rotatable vertical support member 102, a lower solar panel support member 104, an upper solar panel support member 105, and at least one solar panel 500 having a front surface 500A and a rear surface 500B. Optionally, the rotatable vertical support member 102 may be connected to a motor 300 for driving rotation of the rotatable vertical support member 102.

The at least one solar panel 500 is attached to one or more connection members 200, which in turn are connected to the upper solar panel support member 105. The connection member 200 is in the form of a hinge or alternative mechanism, that functions to allow one item to rotate relative to another item. In this case, the solar panel 500 rotates relative to the upper solar panel support member 105, while the upper solar panel support member 105 remains static.

The motor 300 rotates the rotatable vertical support member 102, to place the solar panel mounting system into a desired orientation relative to the position of the sun in the sky, or direction of wind force present. One desired position may be such that the rear surface 500B is facing the direction of any wind force present, upon the wind force contacting the rear surface 500B, the rear surface 500B will rotate around the upper solar panel support member 105 by the connection member(s) 200. FIG. 2 demonstrates an example of the solar panel mounting system 100 shown in FIG. 1, where the solar panel 500 is rotated in the presence of wind from direction X.

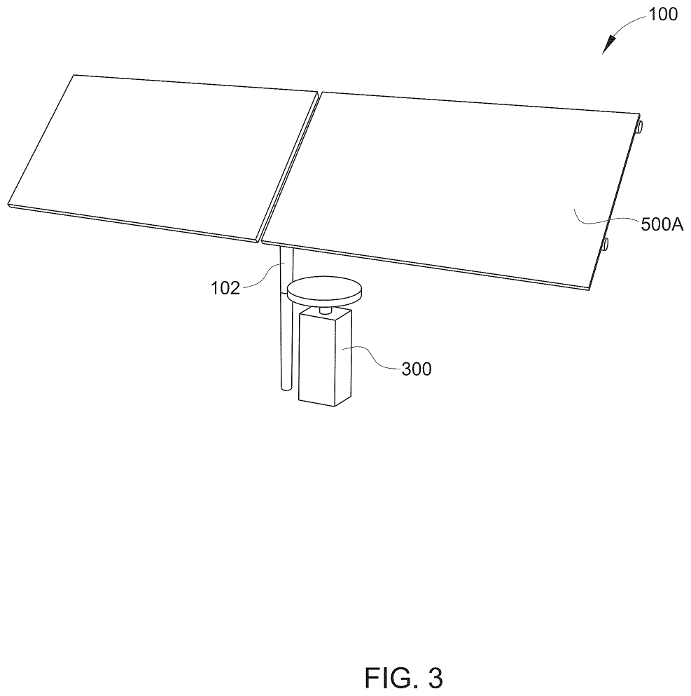

FIG. 3 shows the solar panel mounting system of FIGS. 1 and 2, where the motor 300 has rotated the solar panel mounting system via the rotatable vertical support member 102. This Figure clearly shows the front surface 500A of the at least one solar panel 500.

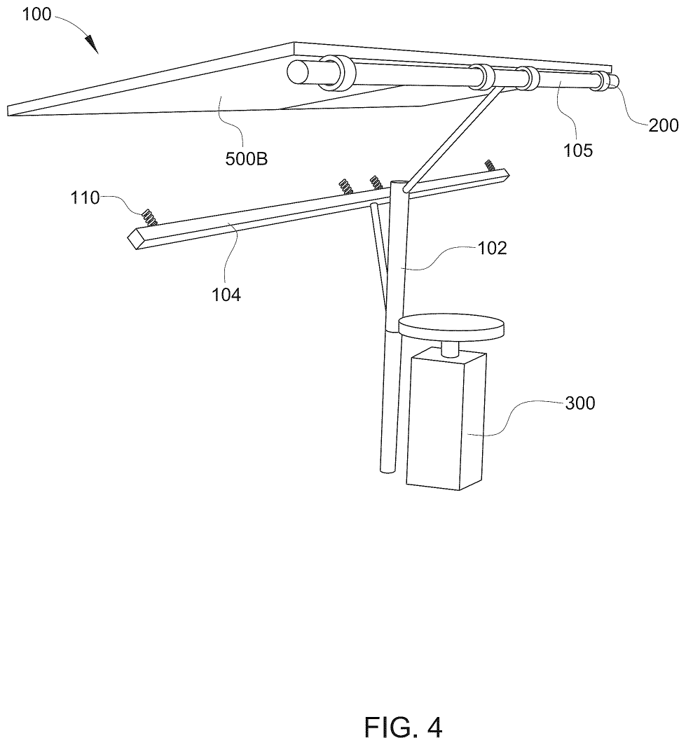

In a further example of the present invention, as shown in FIG. 4, there is provided a solar panel mounting system 100 comprising a rotatable vertical support member 102, a lower solar panel support member 104, an upper solar panel support member 105, and at least one solar panel 500 having a front surface 500A and a rear surface 500B. Optionally, the rotatable vertical support member 102 may be connected to a motor 300 for driving rotation of the rotatable vertical support member 102.

The at least one solar panel 500 is attached to one or more connection members 200, which in turn are connected to the upper solar panel support member 105. The connection member 200 is in the form of a hinge or alternative mechanism, that functions to allow one item to rotate relative to another item. In this case, the solar panel 500 rotates relative to the upper solar panel support member 105, while the upper solar panel support member 105 remains static. Provided on the lower solar panel support member 104 are one or more dampening members 110, which function to cushion the contact between the one or more solar panels 500 and the lower solar panel support member 104. The dampening members 110 may be a piece of foam, rubber or similar soft material, alternatively they may be a spring or other elastic component. Any material or component capable of cushioning contact between two items may be suitable for use as a dampening member, as would be readily understood by a person of skill in the art.

The motor 300 rotates the rotatable vertical support member 102, to place the solar panel mounting system into a desired orientation relative to the location of the sun in the sky, or the direction of wind force present. One desired position may be such that the rear surface 500B is facing the direction of any wind force present, upon the wind force contacting the rear surface 500B, the rear surface 500B will rotate around the upper solar panel support member 105 by the connection member(s) 200.

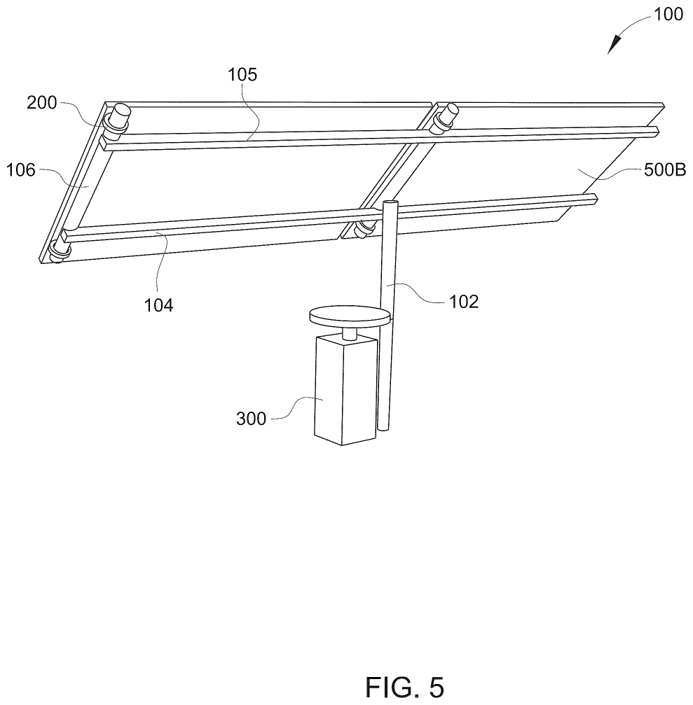

In a further example of the present invention, as shown in FIG. 5, there is provided a solar panel mounting system 100 comprising a rotatable vertical support member 102, a lower solar panel support member 104, an upper solar panel support member 105, at least one vertical solar panel support member 106, and at least one solar panel 500 having a front surface 500A and a rear surface 500B. Optionally, the rotatable vertical support member 102 may be connected to a motor 300 for driving rotation of the rotatable vertical support member 102.

The at least one solar panel 500 is attached to one or more connection members 200, which in turn are connected to a vertical solar panel support member 106. The connection member 200 is in the form of a hinge or alternative mechanism, that functions to allow one item to rotate relative to another item. In this case, the solar panel 500 rotates relative to the vertical solar panel support member 106, while the vertical solar panel support member 106 remains static.

The motor 300 rotates the rotatable vertical support member 102, to place the solar panel mounting system into a desired orientation relative to the direction of wind force present. One desired position may be such that the rear surface 500B is facing the direction of any wind force present, upon the wind force contacting the rear surface 500B, the rear surface 500B will rotate around the vertical solar panel support member 106 by the connection member(s) 200.

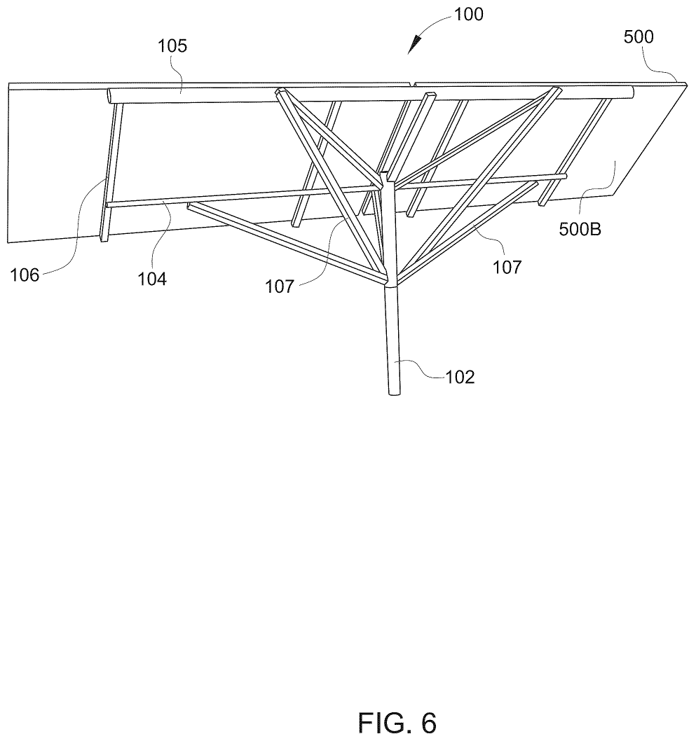

In a further example of the present invention, as shown in FIG. 6, there is provided a solar panel mounting system 100 comprising a rotatable vertical support member 102, a lower solar panel support member 104, an upper solar panel support member 105, at least one vertical solar panel support member 106, at least one diagonal solar panel support member 107, and at least one solar panel 500 having a front surface 500A and a rear surface 500B. Optionally, the rotatable vertical support member 102 may be connected to a motor (not shown) for driving rotation of the rotatable vertical support member 102.

The lower solar panel support member 104, upper solar panel support member 105, vertical solar panel support member 106, and diagonal support member 107 serve to support the at least one solar panel 500 atop the rotatable vertical support member 102. Generally, the greater the number of support members 104 to 107, the more rigid and stable the solar pane mounting system 100 is in the presence of wind force.

The at least one solar panel 500 is attached to one or more connection members 200, which in turn are connected to the upper solar panel support member 105. The connection member 200 is in the form of a hinge or alternative mechanism, that functions to allow one item to rotate relative to another item. In this case, the solar panel 500 rotates relative to the upper solar panel support member 105, while the upper solar panel support member 105 remains static.

The motor 300 rotates the rotatable vertical support member 102, to place the solar panel mounting system into a desired orientation relative to the direction of wind force present. One desired position may be such that the rear surface 500B is facing the direction of any wind force present, upon the wind force contacting the rear surface 500B, the rear surface 500B will rotate around the upper solar panel support member 105 by the connection member(s) 200.

In a further example of the present invention, the rotatable vertical support member 102 may attach directly to the upper solar panel support member 105. Connected to the upper solar panel support member 105 are solar panels 500, connected via connection members 200, as has been previously described.

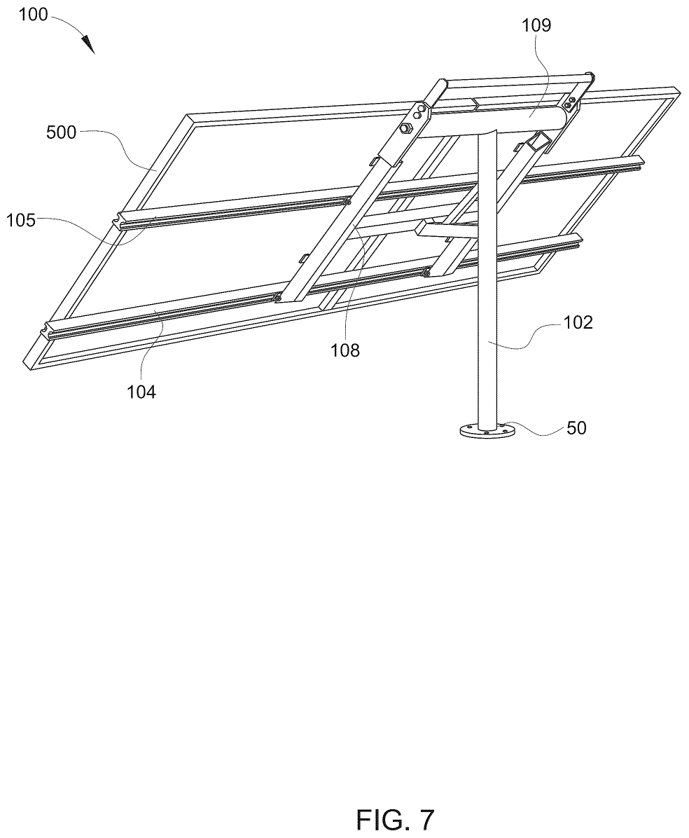

In a further example of the present invention, as shown in FIG. 7, there is provided a solar panel mounting system 100 comprising a rotatable vertical support member 102, a lower solar panel support member 104, an upper solar panel support member 105, and at least one solar panel 500 supported by the upper and lower solar panel support members 105, 104. Located at one distal end of the rotatable vertical support member 102 is a horizontal support member 109, while the other distal end of the rotatable vertical support member 102 is secured to the ground via a foundation 50. The rotatable vertical support member 102 may rotate around the foundation 50 using a ball bearing joint. Attached to the horizontal support member 109 are arms 108, which further attach to the upper and lower support members 105, 104. The horizontal support member 109 is rotatable such that rotation of the horizontal support member (such as via wind force) causes the arms 108 to raise, and in turn raise the upper and lower support members 105, 104 which in turn raise the at least one solar panel 500.

In a further improvement of the present invention, according to any of the examples herein described, a measurement device (not shown) may be used to drive rotation of a solar panel 500 via a motor 300. The measurement device may measure properties of wind or other external force present, these properties include but are not limited to speed, and direction. Upon the measurement device measuring a property at a predetermined threshold, or meeting a different condition, the motor may be directed to rotate the solar panel 500 to a determined orientation. This determination of the required orientation, and control of the motor may be performed by a computing unit (not shown). Ideally, the solar panel 500 is rotated such that the rear surface 500B faces a direction that allows the solar panel 500 to minimize the force excerpted by the wind upon the panel 500 by means of rotating to a position with reduced angle of attack with respect to the wind, the direction of wind force present, such that the wind force causes the solar panel 500 to rotate to a position such as that demonstrated in FIG. 2, whereby the solar panel 500 is substantially parallel to the direction of the wind. In this manner, in the presence of high wind or other external forces, the solar panel 500 may rotate to a position whereby wind or other external force is permitted to pass by the solar panel 500, with minimal resistance.

In all embodiments and examples of the present invention, the solar panel mounting system 100 may be secured to the ground via a ground anchor (not shown) or similar. The ground anchor may be attached to the vertical support member 102. The ground anchor may be in the form of a ground screw as would be understood by a person of skill in the art, preferably the ground screw extends above ground by approximately 20-80 cm and contains a hollow aperture within which the vertical support member 102 may be placed. Is this manner, the ground anchor is embedded within the ground, and the vertical support member 102 is secured within it. This provides a solid and stable foundation for the solar panel mounting system 100. Other forms of ground anchors would also be suitable as would be understood by a person of skill in the art., for example multiple ground anchors 103 could be embedded in the ground at different angles, or alternative ballast or weight could be placed atop the ground in the place of a ground anchor. The ground anchors for example may be in the form of a screw which upon rotation into the ground secures the ground anchor within the ground, or they may be in the form of a metal bar having a cross section designed to provide strength, which may include a “C” cross section, “H” cross section, “I” cross section or the like, which may be driven into the ground by force. Further, the ground anchor may have a substantially flat bottom portion.

The present invention will now be described with regard to the general logic for controlling the solar panel mounting system 100. When wind force meeting a predefined threshold is forecast, the measured wind speed meets a predefined threshold, or other forces meet a predefined threshold, it is optimal for the solar panel mounting system 100 to rotate such that the solar panels to meet a desired condition, for example:
An angle which allows the solar panels to rotate while avoiding resonance or turbulence.
An angle which allows efficient maintenance of the solar panel mounting system to be carried out.
An angle which allows for the maintenance, planting, or care of grass or crops located below the solar panel mounting system. For example, in the case of multiple solar panel mounting systems, all panels in a single row of solar panel mounting systems may be rotated to maximize space for machinery, or every second row could be rotated 180 degrees differently.

In a further improvement of the present invention, it is possible that any rotated of the solar panel mounting system may be controlled by a remote system, such as via an app on a phone. The app may communicate directly, or via a remote server, with motors which control rotation of individual or a group of solar panel mounting systems.

The present invention will now be described with reference to solar tracking systems. A solar tracking system moves the solar panels in a solar system to track the sun's movement across the sky to maximize electricity production. Traditionally, there are three forms of solar tracking systems, dual axis trackers, horizontal single-axis trackers (HSAT), and vertical single-axis trackers (VSAT). Dual axis trackers rotate solar panels around both a horizontal and vertical axis, HSAT rotate solar panels around a horizontal axis, and VSAT rotate solar panels around a vertical axis.

The present invention relates to solar mounting systems that operate like a VSAT which adapt to the presence of wind, by allowing wind to control rotation of solar panels around a horizontal axis. When wind blows towards rotatable solar panels, with a vertical rotation axis in, or near, the center of the solar panels, the wind will induce torque on the solar panels that will—unless the surface is limited from rotating in some way—rotate the solar panels to face the wind. By making it possible for the solar panels to rotate around a horizontal axis based on the wind, the surface can rotate around this horizontal axis away from the wind and as a result reduce this torque.

Further when the wind blows toward solar panels, the wind will induce force on the solar panels that can damage or topple the solar panel structure unless it is strong enough to handle this force and attached firmly enough not to topple. By making it possible for the solar panels to rotate around a horizontal axis based on the wind, this will cause less strain on the solar panels and make it harder for the wind to topple the body.

In order to efficiently operate the solar panel mounting system according to the present invention, it is preferable that the tracking of the sun by the solar panel mounting system is efficient with regard to all variables. For example, in the case of the solar panel mounting system being placed in the northern hemisphere, it is desirable for the solar panels to face toward the southeast in the morning, the south at midday, and southwest in the afternoon and evening. Preferably the configuration of solar panels in the solar panel mounting system are optimised to form as close as possible to a solid line when facing southeast and southwest, while minimising the presence of shadows cast behind them. This optimises land use density. The exact aspect ratio of solar panels can vary depending on latitude and desired land density and shadowing, but for example a ratio of 3:1 width:height may be suitable.

It should be understood by a person of skill in the art that the material chosen to manufacture the solar panel mounting system 100 from is important, it may be a lightweight material such as aluminium or the like, or portions of the system 100 may be manufactured from a heavier material such as steel to provide ballast to the system 100.

The solar panel mounting system described herein is versatile and can be used with various types of solar panels. This includes, but is not limited to, crystalline silicon solar panels, thin-film solar panels, and other photovoltaic technologies. The system's design allows for easy adaptation to different panel sizes, shapes, and configurations, ensuring compatibility with a wide range of commercially available solar panels. Whether the solar panels are framed or frameless, the mounting system can securely support and optimize their orientation for maximum sunlight capture and wind resistance. This flexibility makes the invention suitable for diverse applications, from residential rooftop installations to large-scale solar farms.

1. A solar panel mounting system for mounting one or more solar panels, including:
at least one solar panel,
a lower solar panel support member for supporting the at least one solar panel in a rest position,
an upper solar panel support member rotatably attached to the solar panel,
a rotatable vertical support member supporting a solar panel support member,
a motor connected to the rotatable vertical support member for driving rotation of the rotatable vertical support member,
a computing unit for controlling the motor,
wherein the computing unit is configured to control the motor to rotate the rotatable vertical support member such that the rear surface of the at least one solar panel faces the direction of incoming wind and wherein the system is configured such that wind force upon the rear surface of the at least one solar panel causes the at least one solar panel to rotate around the upper solar panel rotation member out of the rest position.

2. The solar panel mounting system of claim 1, wherein the computing unit is configured to determine the future direction of incoming wind.

3. The solar panel mounting system of claim 2, wherein the computing unit is configured to control the motor to rotate the rotatable vertical support member such that a surface of the at least one solar panel faces the determined future direction of incoming wind.

4. The solar panel mounting system of claim 1, wherein the computing unit is configured to control the motor to rotate the rotatable vertical support member such that a surface of the at least one solar panel faces within seventy degrees of the direction of present or predicted incoming wind.

5. The solar panel mounting system of claim 1, further comprising a ground anchor attached to the rotatably vertical support member for attaching the solar panel structure to the ground.

6. The solar panel mounting system of claim 1, further comprising a measurement device configured to measure properties of wind including at least wind speed and wind direction, wherein the computing unit is configured to control the motor to rotate the rotatable vertical support member in response to the measurement device detecting that a measured property meets a predefined threshold.

7. The solar panel mounting system of claim 1, wherein the lower solar panel support member carries one or more dampening members configured to cushion contact between the at least one solar panel and the lower solar panel support member when the at least one solar panel returns to the rest position.

8. The solar panel mounting system of claim 1, wherein the rotatable attachment between the at least one solar panel and the upper solar panel support member comprises a hinge connection member permitting the at least one solar panel to rotate relative to the upper solar panel support member.

9. The solar panel mounting system of claim 5, wherein the ground anchor comprises a ground screw that extends approximately 20-80 cm above ground, and defines a hollow aperture within which the rotatable vertical support member is received.

10. The solar panel mounting system of claim 1, wherein the computing unit is further configured to control the motor to track the position of the sun across the sky.

11. The solar panel mounting system of claim 1, further comprising an inner vertical member fixed to the ground, the rotatable vertical support member being mounted around the inner vertical member and rotatable relative thereto.

12. The solar panel mounting system of claim 11, further comprising bearings positioned adjacent a top of the inner vertical member and a bottom of the rotatable vertical support member to reduce friction during rotation.

13. The solar panel mounting system of claim 1, further comprising a communication interface configured to receive control instructions from a remote system including an app on a phone, the app communicating directly or via a remote server with the motor.

14. The solar panel mounting system of claim 13, wherein the communication interface is configured to receive control instructions from the remote system to rotate the rotatable vertical support member for operation of an individual system or a group of systems, including rotating all panels in a row of solar panel mounting systems to maximize space for machinery, or alternating orientation by 180 degrees for every second row.

15. The solar panel mounting system of claim 6, wherein the predefined threshold is a wind speed threshold.

16. The solar panel mounting system of claim 1, configured to operate like a vertical single-axis tracker (VSAT), wherein when installed in the northern hemisphere the computing unit controls the motor to orient the at least one solar panel toward the southeast in the morning, toward the south at midday, and toward the southwest in the afternoon and evening.

17. The solar panel mounting system of claim 1, comprising at least two solar panels.

18. The solar panel mounting system of claim 1, wherein a solar panel has an aspect ratio of 3:1 (width:height).

19. The solar panel mounting system of claim 1, further comprising a horizontal axis fixedly attached to the rotatable vertical support member, wherein a point of attachment of the horizontal axis to the rotatable vertical support member is at or around a center of the horizontal axis.
